(19) United States
(12) Patent Application Publication
(10) Pub. No.: US 2017/0289690 A1
(43) Pub. Date: Oct. 5, 2017

(54) VIBRATING DIAPHRAGM STRUCTURE AND METHOD OF MANUFACTURE THEREOF

(71) Applicant: Cheng Uei Precision Industry Co., Ltd., New Taipei City (TW)

(72) Inventors: James Lee, New Taipei City (TW); Yi Lin Yang, New Taipei City (TW)

(21) Appl. No.: 15/083,291

(22) Filed: Mar. 29, 2016

(51) Int. Cl. H04R 7/06; H04R 31/00

(52) U.S. Cl. CPC H04R 7/06; H04R 31/003; H04R 2307/204; H04R 2307/023; H04R 2307/207

(57) ABSTRACT

A vibrating diaphragm includes a diaphragm body and a suspension edge. The diaphragm body is made by acrylonitrile butadiene styrene materials. A surface of the diaphragm body is electroplated a layer of nanoscale materials. The suspension edge is made by room temperature vulcanized silicone rubber materials. The suspension edge is molded an outer periphery of the diaphragm body. The vibrating diaphragm can improve the high frequency effect of the speaker.

### BACKGROUND OF THE INVENTION

### 1. Field of the Invention

The present invention relates to a speaker, and more particularly to a vibrating diaphragm structure of the speaker and method of manufacture thereof.

### 2. The Related Art

A traditional vibrating diaphragm structure includes an annular-shaped suspension edge and a circular-shaped diaphragm body. The suspension edge is a plastic material and the diaphragm body is a paper material. The diaphragm body is stuck on the suspension edge by glue and seals a hollow part of the suspension edge. The centers of the diaphragm body and the suspension edge are the same.

However, when the diaphragm body is stuck on the suspension edge by an operator, a position deviation usually occurs to result in the centers of the diaphragm body and the suspension edge are not the same. Thus it greatly affects a distortion and a sound quality of the speaker. Also, the diaphragm body uses the paper material shows a poor performance in high frequency.

### SUMMARY OF THE INVENTION

Accordingly, an object of the present invention is to provide a vibrating diaphragm mounted on a speaker. The vibrating diaphragm includes a diaphragm body and a suspension edge. The diaphragm body is made by acrylonitrile butadiene styrene materials. A surface of the diaphragm body is electroplated a layer of nanoscale materials. The suspension edge is made by room temperature vulcanized silicone rubber materials. The suspension edge is molded an outer periphery of the diaphragm body.

Accordingly, a manufacture method of the vibrating diaphragm: molding a circular-shaped diaphragm body using acrylonitrile butadiene styrene materials; electroplating a layer of nanoscale materials to the surface of the diaphragm body; placing the diaphragm body in a mould, and molding the room temperature vulcanization silicone rubber on the outer periphery of the diaphragm body to form an annular-shaped suspended edge, the inner periphery of the suspension edge having an annular-shaped slot, the outer periphery of the diaphragm body fixed in the slot of the suspension edge, and the centers of the diaphragm body and the suspension edge being the same.

As described above, the diaphragm body of the vibrating diaphragm is made by ABS materials, the surface of the diaphragm body is electroplated a layer of nanoscale materials, and the room temperature vulcanization silicone rubber is molded on the outer periphery of the diaphragm body to form the suspended edge to make sure the centers of the diaphragm body and the suspension edge are the same, which improves the high frequency effect of the speaker with the vibrating diaphragm.

### BRIEF DESCRIPTION OF THE DRAWINGS

The present invention will be apparent to those skilled in the art by reading the following description thereof, with reference to the attached drawings, in which:

FIG. 1 is an assembled, perspective view of a vibrating diaphragm in accordance with an embodiment of the present invention;

FIG. 2 is another angle assembled, perspective view of the vibrating diaphragm shown in FIG. 1;

FIG. 3 is an exploded, perspective view of the vibrating diaphragm shown in FIG. 1;

FIG. 4 is a diagram showing frequency response curves of a speaker with the vibrating diaphragm of FIG. 1 and another speaker with the vibrating diaphragm with paper material in the related art; and

FIG. 5 is a diagram showing the total harmonic distortion rate of the speaker with the vibrating diaphragm of FIG. 1 and the speaker with the vibrating diaphragm with paper material in the related art.

### DETAILED DESCRIPTION OF THE EMBODIMENT

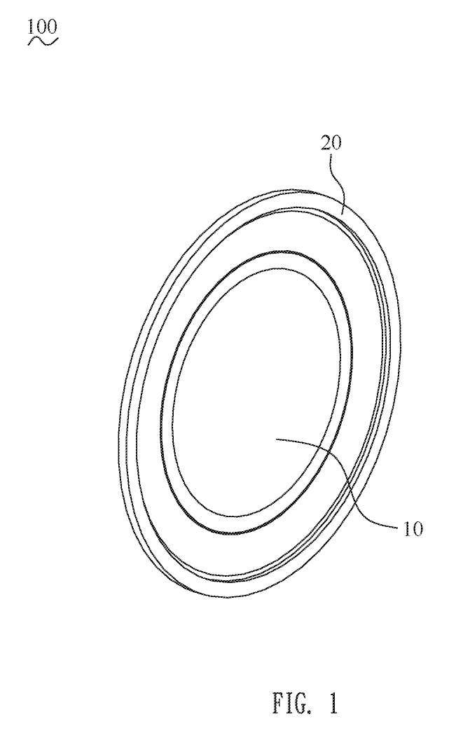

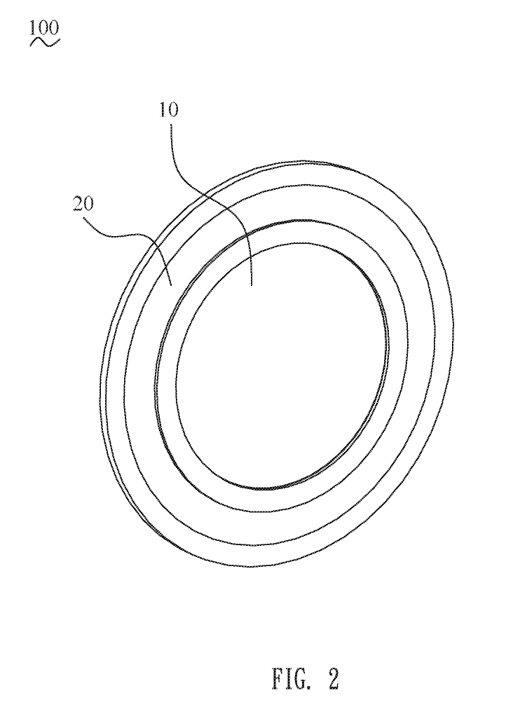

Referring to the drawings in greater detail, and first to FIG. 1 and FIG. 2, an embodiment of the present invention is embodied in a vibrating diaphragm 100 mounted on a speaker (not shown). The vibrating diaphragm 100 includes a diaphragm body 10 and a suspension edge 20.

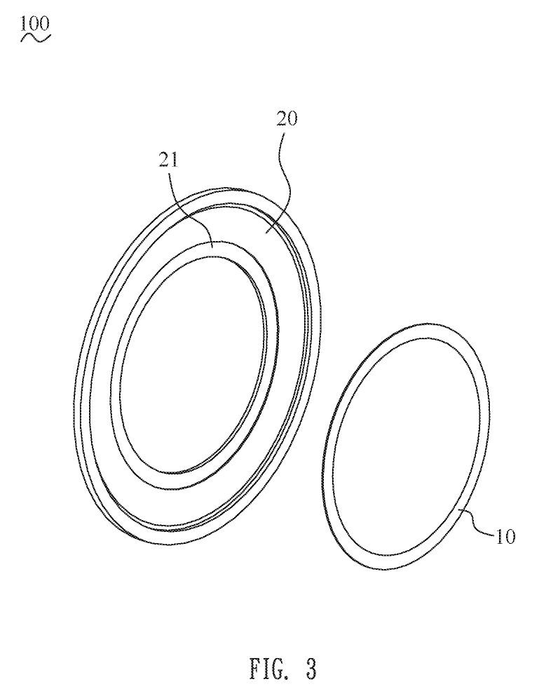

Referring to FIG. 3, the diaphragm body 10 is a circular-shaped diaphragm body. The diaphragm body 10 is made by Acrylonitrile Butadiene Styrene (ABS) materials. A surface of the diaphragm body 10 is electroplated a layer of nanoscale materials.

The suspension edge 20 is an annular-shaped sheet. The suspension edge 20 is made by room temperature vulcanized silicone rubber materials. The suspension edge 20 is molded to an outer periphery of the diaphragm body 10. An inner periphery of the suspension edge 20 has an annular-shaped slot 21. An outer periphery of the diaphragm body 10 is fixed in the slot 21 of the suspension edge 20. The centers of the diaphragm body 10 and the suspension edge 20 are the same.

Specific steps of the manufacture method of the vibrating diaphragm 100 in accordance with the embodiment of the present invention are described as follows:

Step one: molding a circular-shaped diaphragm body 10 using acrylonitrile butadiene styrene materials;

Step two: electroplating a layer of nanoscale materials to the surface of the diaphragm body 10;

Step three: placing the diaphragm body in a mould, and molding the room temperature vulcanization silicone rubber on the outer periphery of the diaphragm body to form an annular-shaped suspended edge, the inner periphery of the suspension edge having an annular-shaped slot, the outer periphery of the diaphragm body fixed in the slot of the suspension edge, and the centers of the diaphragm body and the suspension edge being the same.

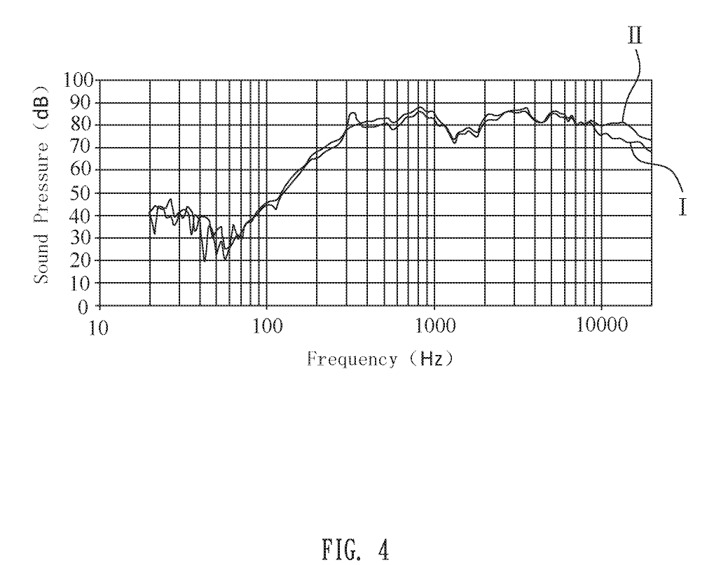

Referring to FIG. 4, which shows frequency response curves of the speaker with the vibrating diaphragm 100 and another speaker with the vibrating diaphragm with paper material in the related art, a curve I shows the frequency response of the speaker with the vibrating diaphragm with paper material and a curve II shows the frequency response of the speaker with the vibrating diaphragm 100. In low frequency, the sound pressure of the speaker with the vibrating diaphragm 100 and the speaker with the vibrating diaphragm with paper material have almost no difference, but in high frequency, the sound pressure of the speaker with the vibrating diaphragm 100 is improved 5dB than the speaker with the vibrating diaphragm with paper material. Therefore, a high frequency effect of the speaker with the vibrating diaphragm 100 is improved.

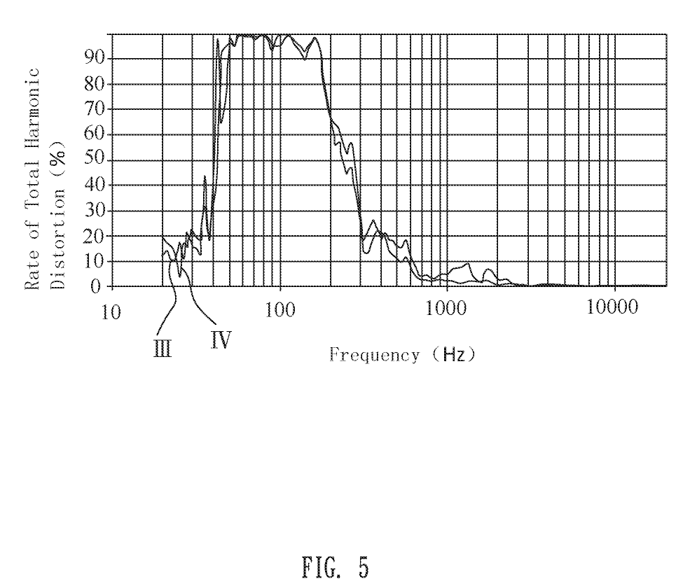

Referring to FIG. 5, which shows the total harmonic distortion rate of the speaker with the vibrating diaphragm 100 and the speaker with the vibrating diaphragm with paper material, a curve III shows the total harmonic distortion rate of the speaker of the vibrating diaphragm with paper material and a curve IV shows the total harmonic distortion rate of the speaker with the vibrating diaphragm 100, the curve III and the curve IV are almost no difference.

As described above, the diaphragm body 10 of the vibrating diaphragm 100 is made by ABS materials, the surface of the diaphragm body 10 is electroplated a layer of nanoscale materials, and the room temperature vulcanization silicone rubber is molded on the outer periphery of the diaphragm body 10 to form the suspended edge 20 to make sure the centers of the diaphragm body 10 and the suspension edge 20 are the same, which improves the high frequency effect of the speaker with the vibrating diaphragm 100.

What is claimed is:

1. A vibrating diaphragm mounted on a speaker, comprising:
a diaphragm body made by acrylonitrile butadiene styrene materials, a surface of the diaphragm body being electroplated a layer of nanoscale materials; and
a suspension edge made by room temperature vulcanized silicone rubber materials, the suspension edge being molded with an outer periphery of the diaphragm body.

2. The vibrating diaphragm as claimed in claim 1, wherein the diaphragm body is a circular-shaped, the suspension edge is an annular-shaped sheet.

3. The vibrating diaphragm as claimed in claim 2, wherein an inner periphery of the suspension edge has an annular-shaped slot, an outer periphery of the diaphragm body is fixed in the slot of the suspension edge, the centers of the diaphragm body and the suspension edge are the same.

4. A manufacture method of the vibrating diaphragm, comprising:
step one: molding a circular-shaped diaphragm body using acrylonitrile butadiene styrene materials;
step two: electroplating a layer of nanoscale materials to the surface of the diaphragm body;
step three: placing the diaphragm body in a mould, and molding the room temperature vulcanization silicone rubber on the outer periphery of the diaphragm body to form an annular-shaped suspended edge, the inner periphery of the suspension edge having an annular-shaped slot, the outer periphery of the diaphragm body fixed in the slot of the suspension edge, and the centers of the diaphragm body and the suspension edge being the same.
